(19) United States
(12) Patent Application Publication
(10) Pub. No.: US 2020/0382826 A1
(43) Pub. Date: Dec. 3, 2020

(54) BACKGROUND ENHANCEMENT IN DISCRIMINATIVELY ENCODED VIDEO

(71) Applicant: International Business Machines Corporation, Armonk, NY (US)

(72) Inventors: Su Liu, Austin, TX (US); Inseok Hwang, Austin, TX (US); Jinho Lee, Travis, TX (US); Matthew H. Tong, Austin, TX (US)

(73) Assignee: International Business Machines Corporation, Armonk, NY (US)

(21) Appl. No.: 16/425,838

(22) Filed: May 29, 2019

(51) Int. Cl. H04N 21/431; H04L 29/06; H04N 21/4728; H04N 21/44

(52) U.S. Cl. CPC H04N 21/431; H04N 21/44008; H04N 21/4728; H04L 65/607

(57) ABSTRACT

A method for enhancing background content in discriminatively encoded video is disclosed. In one embodiment, such a method includes providing video content in the form of point-of-interest content and background content. The background content is of lower visual quality than the point-of-interest content. The method provides an enhancement model that may be applied to the background content to enhance the visual quality of the background content and thereby yield enhanced background content. The method further enables the enhanced background content to be combined with the point-of-interest content to yield combined content that may be viewed by a user. A corresponding system and computer program product are also disclosed.

### BACKGROUND

### Field of the Invention

This invention relates to systems and methods for enhancing background content in discriminatively encoded video.

### Background of the Invention

For a given bit rate limit, the quality of compressed video largely depends on the dynamicity of the scene. In general, the more dynamic the scenes are, the poorer the quality that a user will see. In many categories of video content, there are often one or more points-of-interest (POIs) in a frame. For example, in a music concert video, the performers would likely be the major points-of-interest, while the stage background is likely of less interest. In a video of a sports game, the players are likely the major points-of-interest, while the background (e.g., the playing field and/or audience area) is of less interest. In such types of video content, a user's eye is typically drawn to the points-of-interest and less drawn to the background.

Nevertheless, current video encoders typically do not discriminate between point-of-interest content and background content (i.e., non-point-of-interest content) in videos. The entire frame is typically compressed in the same way, thereby degrading the quality of the point-of-interest content in the same way as the background content. This also inefficiently utilizes bandwidth when streaming videos over a network having a given bit rate limit. When background content has unnecessary spatial/temporal dynamicity, a conventional video encoder typically allocates more information to the background content to deal with the dynamicity. Similarly, even though point-of-interest content is more important to the user, the point-of-interest content may be allocated less information due to the complex background content. This behavior results in various visual artifacts around and/or within the points-of-interest, thereby degrading a user's viewing experience.

In view of the foregoing, what are needed are systems and methods to enable video encoders to discriminate between point-of-interest content and background content. This will ideally enable the video encoders to allocate more information to point-of-interest content and less information to background content. In such systems and methods, techniques are also needed to enhance the visual quality of background content that has been allocated less information.

### SUMMARY

The invention has been developed in response to the present state of the art and, in particular, in response to the problems and needs in the art that have not yet been fully solved by currently available systems and methods. Accordingly, systems and methods have been developed to enhance background content in discriminatively encoded video. The features and advantages of the invention will become more fully apparent from the following description and appended claims, or may be learned by practice of the invention as set forth hereinafter.

Consistent with the foregoing, a method for enhancing background content in discriminatively encoded video is disclosed. In one embodiment, such a method includes providing video content in the form of point-of-interest content and background content. The background content is of lower visual quality than the point-of-interest content. The method provides an enhancement model that may be applied to the background content to enhance the visual quality of the background content and thereby yield enhanced background content. The method further enables the enhanced background content to be combined with the point-of-interest content to yield combined content that may be viewed by a user.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use with embodiments of the invention;

FIG. 2 is a flow diagram showing one embodiment of a method for producing discriminatively encoded video;

FIG. 3 is a high-level diagram showing identification of points-of-interest in a frame of video content;

FIG. 4 is a high-level diagram showing segmentation of a frame of video content to differentiate point-of-interest content from background content;

FIG. 5 is a high-level diagram showing a technique for enhancing the visual quality of background content; and

FIG. 6 is a flow diagram showing one embodiment of a method for enhancing the visual quality of background content in discriminatively encoded video.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

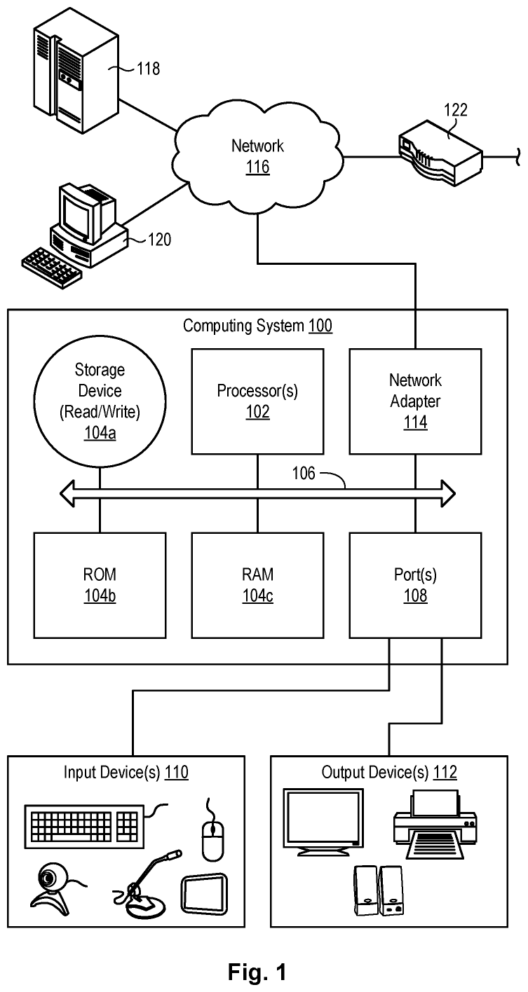

Referring to FIG. 1, one example of a computing system 100 is illustrated. The computing system 100 is presented to show one example of an environment where a system and method in accordance with the invention may be implemented. The computing system 100 may be embodied as a mobile device 100 such as a smart phone or tablet, a desktop computer, a workstation, a server, a storage controller, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a local area network (LAN), wide area network (WAN), storage area network (SAN), or the Internet. Such a network 116 may enable the computing system 100 to connect to or communicate with one or more servers 118, workstations 120, personal computers 120, mobile computing devices, storage devices, or other devices. The network 116 may also enable the computing system 100 to connect to or communicate with another network by way of a router 122 or other device 122. Such a router 122 may allow the computing system 100 to communicate with servers, workstations, personal computers, storage devices, or other devices located on different networks.

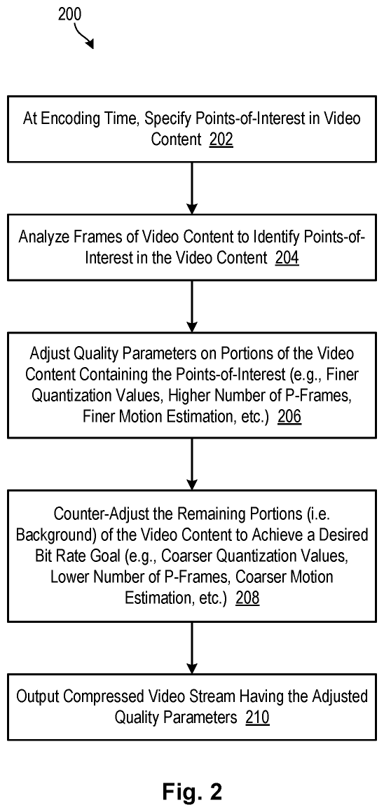

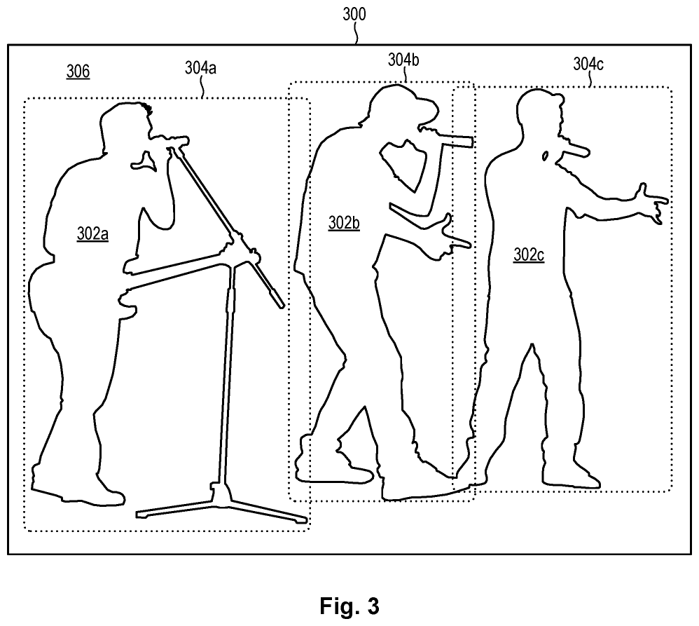

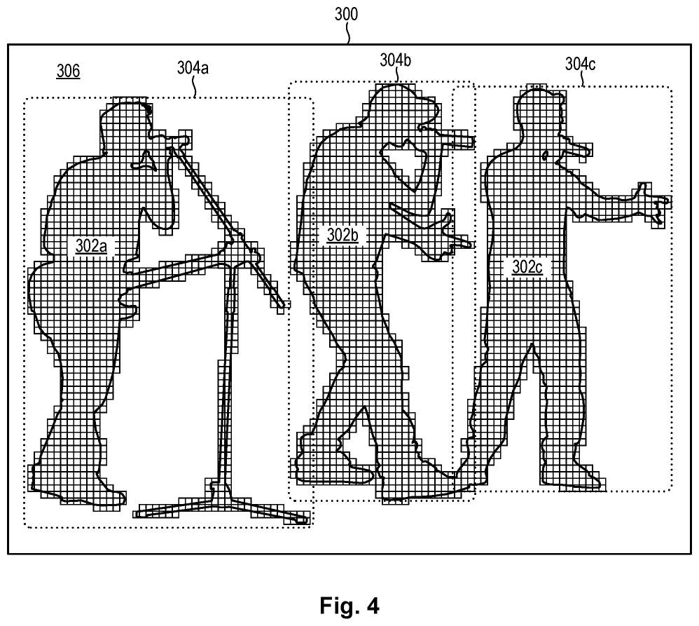

Referring to FIG. 2, as previously mentioned, for a given bit rate limit, the quality of compressed video largely depends on the dynamicity of the scene. In general, the more dynamic a scene, the poorer the visual quality that a user will see. In many categories of video content, there are often one or more points-of-interest (POIs) in a frame. For example, in a music concert video (as shown, for example, in FIGS. 3 and 4), the performers would likely be the major points-of-interest, while the stage background is likely of less interest. Similarly, in a video of a sports game, the players are likely the major points-of-interest, while the background (e.g., the playing field, audience area, etc.) is likely of less interest. In such video content, a user's eye is typically drawn to the points-of-interest and less drawn to the background.

Unfortunately, many current video encoders do not discriminate between point-of-interest content and background content (i.e., non-point-of-interest content). The entire frame is typically compressed in the same way, thereby degrading the quality of the point-of-interest content in the same way as the background content. This inefficiently utilizes bandwidth when streaming videos over a network that can support a given bit rate. When background content has unnecessary spatial/temporal dynamicity, a conventional video encoder typically allocates more information to the background content to deal with the dynamicity. Similarly, even though point-of-interest content is of greater importance to a user, the point-of-interest content may be allocated less information due to the complex background content. This treatment of the point-of-interest and background content may result in various visual artifacts around and within the points-of-interest, thereby degrading a user's viewing experience.

Thus, systems and methods are needed to enable video encoders to discriminate between point-of-interest content and background content. Such systems and methods will ideally allocate more information to point-of-interest content than to background content. In such systems and methods, techniques are also needed to enhance the visual quality of background content that has been allocated less information.

FIG. 2 shows one embodiment of a method 200 for discriminatively encoding video such that point-of-interest content contains more information than background content. As shown in FIG. 2, at the time of encoding, the method 200 specifies 202 points-of-interest to be identified in input video content. A specification defining a point-of-interest may be received from any source, e.g., a video producer preference, an automated agent, metadata associated with the video data, a user profile, metadata associated with the video, etc. Moreover, a point-of-interest may be any type of point-of-interest, e.g., an active portion of the video data (such as defined by a conglomeration of macroblocks in a frame that contain vectors), similar subjects of the video data (such as portions of frames in the video data that depict multiple common patterns), a centered portion of frames in the video data, etc.

The method 200 then analyzes 204 frames 300 of the video content to identify the specified points-of-interest 302 therein. This analysis step 204 may include using one or more types of frame analysis. For example, in one approach, the frames 300 of the video data are analyzed by a type of object detector, as shown in FIG. 3. In another approach, the frames 300 of the video data are additionally and/or alternatively analyzed by a type of object segmenter, as shown in FIG. 4. As shown in FIG. 3, an object detector may be utilized to identify portions 304a-c of a frame 300 that include at least one point-of-interest 302. An object segmenter, by contrast, may be used to split the points-of-interest 302 from the rest of the scene in the video frames 300. For example, the object segmenter may be utilized for splitting a conglomeration of identified points-of-interest 302 into distinct points-of-interest 302. Specifically, as shown in FIG. 4, the object segmenter is utilized for identifying which pixels within a defined portion of a frame 300 relate to the point-of-interest 302, and which pixels within the defined portion 304 of the frame do not relate to the point-of-interest 302.

Once the points-of-interest 302 are identified in the frames 300 of the video content, the method 200 may adjust 206 quality parameters for portions (e.g., pixels) of the video content that contain the points-of-interest 302. This may include, for example, providing finer quantization values, an increased number of P-frames, and/or finer motion estimation for portions 304 of the video content that contain points-of-interest 302. In general, the step 206 may allocate more information to portions 304 of the video content that contain points-of-interest 302 in order to provide more visual quality to these portions 304.

On the other hand, the method 200 may counter-adjust 208 quality parameters of the portions 306 of the video content that do not contain points-of-interest (i.e., the background 306) in order to stay within a bit rate limit when transmitting the encoded video content over a network. This may include, for example, providing coarser quantization values, a decreased number of P-frames, and/or coarser motion estimation for portions of the video content that do not contain points-of-interest. In general, the step 208 may allocate less information to portions 306 of the video content that do not contain points-of-interest 302, thereby reducing its visual quality while enabling the video content as a whole to achieve a desired bit rate goal.

Once the method 200 has adjusted the quality parameters of both the points-of-interest 302 and background 306, the method 200 may output 210 a compressed video stream having the adjusted quality parameters. This video stream may include both the high quality points-of-interest as well as the reduced quality background. One embodiment of a system and method for discriminatively encoding video in the manner described in FIG. 2 is disclosed in U.S. patent application Ser. No. 16/159,467, which shares inventors with the instant application.

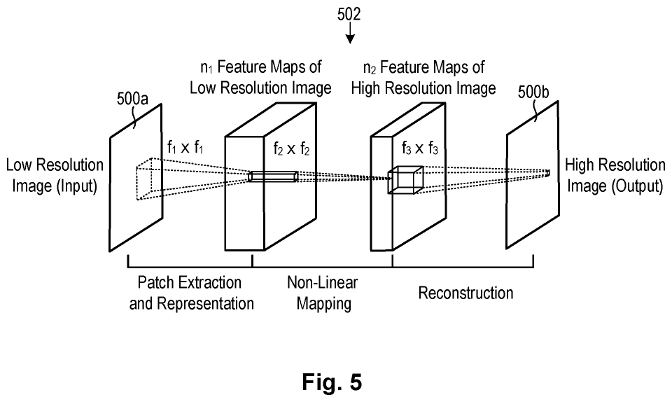

Referring to FIG. 5, due to the low visual quality of the background content 306, systems and methods may be provided to improve the visual quality of the background content 306 when the frame 300 is decoded. In certain embodiments, this decoding occurs by a client device 100 that plays the video content. In certain embodiments, a convolution neural network (CNN) 502 or other enhancement model 502 may be used to transform a low-resolution image 500a to a high resolution image 500b, as shown in FIG. 5. Such an enhancement model 502 may, in certain embodiments, be used to enhance the visual quality of the background content 306 previously described. In the enhancement model 502 illustrated in FIG. 5, given a low resolution image 500a, a first convolution layer extracts a set of feature maps. A second layer maps these feature maps nonlinearly to high-resolution patch representations. A last layer combines predictions within a spatial neighborhood to produce a final high-resolution image 500b. Such an enhancement model 502 is described in an article entitled “Image Super-Resolution Using Deep Convolutional Networks” published on Feb. 1, 2016 and authored by Dong et al.

Other examples of enhancement models 502 that may be used to enhance the visual quality of background content 306 are disclosed in articles entitled “Accurate Image Super-Resolution Using Very Deep Convolutional Networks” published on Nov. 14, 2015 and authored by Kim et al., and “Photo-Realistic Single Image Super-Resolution Using a Generative Adversarial Network” published on Sep. 15, 2016 and authored by Ledig et al.

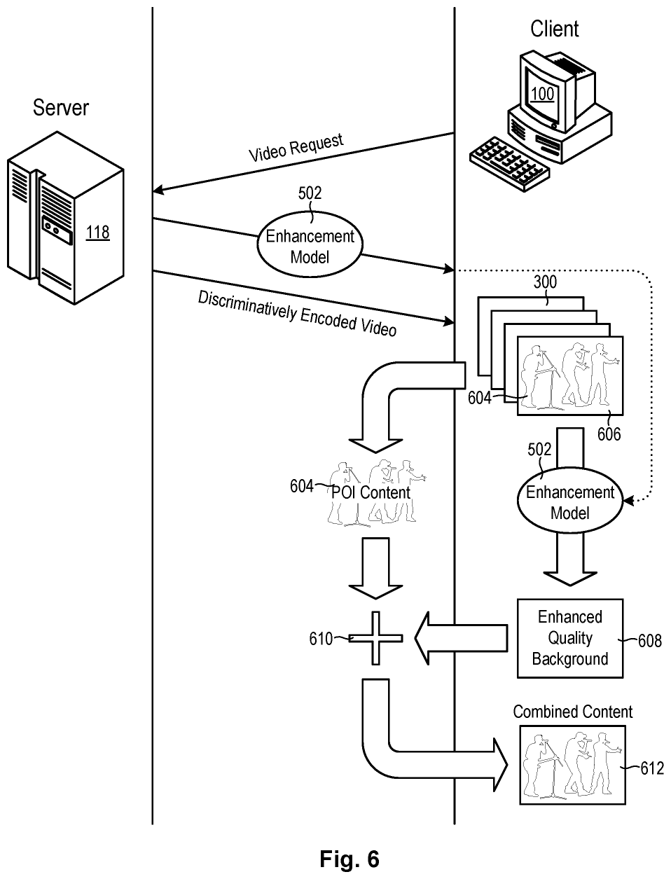

Referring to FIG. 6, a flow diagram showing one embodiment of a process for enhancing the visual quality of background content 606 in discriminatively encoded video is illustrated. As shown, a client device 100 (e.g., a smart phone, tablet, desktop computer, workstation, etc.) may initially send a request to server 118 for video content. The server 118 may retrieve the video content and return discriminatively encoded video to the client device 100 in response to the request. As previously mentioned, discriminatively encoded video may include point-of-interest content 604, encoded with higher visual quality, and background content 306, encoded to have lower visual quality. This may be performed to achieve a bit rate goal associated with transmitting the discriminatively encoded video from the server 118 to the client device 100. The discriminatively encoded video may be transmitted to the client device 100 in the form of one or more frames 300.

The server 118 may also transmit, to the client device 100, an enhancement model 502 configured to enhance the visual quality of the background content 306. The enhancement model 502 may be, for example, an enhancement model 502 described in association with FIG. 5. The client device 100 may receive this enhancement model 502 and apply it to the background content 606, thereby producing enhanced background content 608 having enhanced visual quality. The point-of-interest content 604 may then be added back to or overlaid onto the enhanced background content 608 to produce combined content 612. This combined content 612 may be played on the client device 100 as is or after additional decoding. Due to the increased information in the point-of-interest content 604, the point-of-interest content 604 will be of high visual quality. The enhancement of the background content 606 will also provide improved visual quality to the background content 606.

The timing for transmitting the enhancement model 502 from the server 118 to the client device 100 may differ in different embodiments. In certain embodiments, the enhancement model 502 is transmitted to the client device 100 in advance of the discriminatively encoded video. This will allow the client device 100 to apply the enhancement model 502 to the background content 606 as it is streamed from the server 118. In other embodiments, video content is played on the client device 100 immediately upon reception with or without the enhancement model 502. The client device 100 may begin enhancing the background content 606 of the discriminatively encoded video once the enhancement model 502 is fully received. This may allow unenhanced background content 606 to be played on the client device 100 up until the time the enhancement model 502 is received and applied to the background content 606.

In yet other embodiments, the client device 100 may determine the dominance of point-of-interest content 604 in discriminatively encoded video as it is being played or decoded. The transmission rate of the enhancement model 502 may be adjusted based on the prevalence of point-of-interest content 604 in the discriminatively encoded video. As more point-of-interest content 604 is detected in the discriminatively encoded video, the transmission rate (e.g., download rate) of the enhancement model 502 may be increased so that it is received more expeditiously at the client device 100 and applied to the background content 606.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for enhancing background video content in discriminatively encoded video, the method comprising:
providing video content in the form of point-of-interest content and background content, wherein the background content is of lower visual quality than the point-of-interest content;
providing an enhancement model that may be applied to the background content to enhance the visual quality of the background content and thereby yield enhanced background content; and
enabling the enhanced background content to be combined with the point-of-interest content to yield combined content that may be played to a user.

2. The method of claim 1, wherein providing the video content comprises transmitting the video content to a client device.

3. The method of claim 2, wherein providing the enhancement model comprises transmitting the enhancement model to the client device.

4. The method of claim 3, further comprising applying, by the client device, the enhancement model to the background content to yield the enhanced background content, and combining, by the client device, the enhanced background content with the point-of-interest content to generate the combined content.

5. The method of claim 3, wherein transmitting the enhancement model to the client device comprises transmitting the enhancement model to the client device prior to transmitting the video content to the client device.

6. The method of claim 3, wherein transmitting the enhancement model to the client device comprises transmitting the enhancement model to the client device at a rate that corresponds to an amount of point-of-interest content in the video content.

7. The method of claim 3, wherein transmitting the enhancement model to the client device comprises completing transmission of the enhancement model to the client device after initiating play of the video content on the client device.

8. A computer program product for enhancing background video content in discriminatively encoded video, the computer program product comprising a computer-readable storage medium having computer-usable program code embodied therein, the computer-usable program code configured to perform the following when executed by at least one processor:
provide video content in the form of point-of-interest content and background content, wherein the background content is of lower visual quality than the point-of-interest content;
provide an enhancement model that may be applied to the background content to enhance the visual quality of the background content and thereby yield enhanced background content; and
enable the enhanced background content to be combined with the point-of-interest content to yield combined content that may be played to a user.

9. The computer program product of claim 8, wherein providing the video content comprises transmitting the video content to a client device.

10. The computer program product of claim 9, wherein providing the enhancement model comprises transmitting the enhancement model to the client device.

11. The computer program product of claim 10, wherein the computer-usable program code is further configured to apply the enhancement model to the background content to yield the enhanced background content, and combine the enhanced background content with the point-of-interest content to generate the combined content.

12. The computer program product of claim 10, wherein transmitting the enhancement model to the client device comprises transmitting the enhancement model to the client device prior to transmitting the video content to the client device.

13. The computer program product of claim 10, wherein transmitting the enhancement model to the client device comprises transmitting the enhancement model to the client device at a rate that corresponds to an amount of point-of-interest content in the video content.

14. The computer program product of claim 10, wherein transmitting the enhancement model to the client device comprises completing transmission of the enhancement model to the client device after initiating play of the video content on the client device.

15. A system for enhancing background video content in discriminatively encoded video, the system comprising:
at least one processor;
at least one memory device operably coupled to the at least one processor and storing instructions for execution on the at least one processor, the instructions causing the at least one processor to:
provide video content in the form of point-of-interest content and background content, wherein the background content is of lower visual quality than the point-of-interest content;
provide an enhancement model that may be applied to the background content to enhance the visual quality of the background content and thereby yield enhanced background content; and
enable the enhanced background content to be combined with the point-of-interest content to yield combined content that may be played to a user.

16. The system of claim 15, wherein providing the video content comprises transmitting the video content to a client device.

17. The system of claim 16, wherein providing the enhancement model comprises transmitting the enhancement model to the client device.

18. The system of claim 17, wherein the instructions further cause the at least one processor to apply the enhancement model to the background content to yield the enhanced background content, and combine the enhanced background content with the point-of-interest content to generate the combined content.

19. The system of claim 17, wherein transmitting the enhancement model to the client device comprises transmitting the enhancement model to the client device prior to transmitting the video content to the client device.

20. The system of claim 17, wherein transmitting the enhancement model to the client device comprises transmitting the enhancement model to the client device at a rate that corresponds to an amount of point-of-interest content in the video content.
